(19) United States
(12) Patent Application Publication
(10) Pub. No.: US 2021/0056243 A1
(43) Pub. Date: Feb. 25, 2021

(54) METHOD FOR ESTABLISHING THE GEOMETRICAL IMPERFECTION DATABASE FOR THE AEROSPACE THIN-WALLED STRUCTURE

(71) Applicant: DALIAN UNIVERSITY OF TECHNOLOGY, Dalian, Liaoning (CN)

(72) Inventors: Bo WANG, Dalian, Liaoning (CN); Peng HAO, Dalian, Liaoning (CN); Xiangtao MA, Dalian, Liaoning (CN); Kaifan DU, Dalian, Liaoning (CN); Jie GUO, Dalian, Liaoning (CN); Xi ZHANG, Dalian, Liaoning (CN)

(21) Appl. No.: 16/754,672

(22) PCT Filed: Apr. 17, 2019
(86) PCT No.: PCT/CN2019/083019

§ 371 Date: Apr. 8, 2020

(51) Int. Cl. G06F 30/17; G06F 30/23; G06F 17/18; G06T 17/20

(52) U.S. Cl. CPC G06F 30/17; G06T 17/20; G06F 17/18; G06F 30/23

(57) ABSTRACT

A method for establishing a geometrical imperfection database of aerospace thin-walled structures is disclosed. The method comprises the following steps: 1) design the shell quality inspection card that is suitable and convenient to measure the geometrical imperfections for field workers. Obtain the parameters and geometrical imperfections of shells by filling data of measurement points in the shell quality inspection card; 2) perform characteristics combing, mathematical description and component analysis for the geometrical imperfections obtained in the first step; 3) collect and analyze the geometrical imperfection information of multiple aerospace thin-walled shells and establish the geometrical imperfection database based on the first step and second step. The method will effectively serve the development of aerospace equipment, shorten the design cycle and provide guidance and specifications for the design of the thin-walled components carrying main load.

### FIELD OF THE INVENTION

The invention belongs to the field of analysis and design with respect to the components carrying main load in the aerospace structures, and more particularly relates to a method for establishing a geometrical imperfection database of the aerospace thin-walled structures.

### BACKGROUND OF THE INVENTION

Thin-walled structures are widely used in the aerospace industry as components carrying main load, due to their high stiffness-to-weight and strength-to-weight ratios. They are mainly subjected to axial compression during the launch process, and they are prone to buckling. Therefore, the buckling load under axial compression is generally regarded as one key design load or assessment index in the design of thin-walled cylinders. However, it has been found that there is a large discrepancy between the theoretical values and experimental results for the buckling load of cylindrical shells, though a large number of axial compression tests. The buckling loads obtained by the experimental technologies are often only 20%-60% of the classical theory solution, and the experimental results have great dispersion and difference. After decades of research, it has been found that the existence of initial geometrical imperfections is one of the reasons for the huge discrepancy. But the geometrical imperfections are inevitable in the process of manufacturing, transportation, assembly and service. Therefore, how to accurately consider different forms of geometrical imperfection in buckling analysis is one of the effective ways to accurately predict the buckling load and perform the detailed design of thin-walled structures. The German Aerospace Center adopted the European Steel Shell Code method to evaluate and classify the thin-walled structures according to the initial imperfections, which is considered as the authoritative specification for the stability design of cylindrical shells. NASA measured the initial geometrical imperfections of skin of cylindrical shells by experimental technologies and established an initial geometrical imperfection database, which helps the design of the aerospace thin-walled structures.

The stiffened thin-walled structures are adopted as the main carrying load components of Chinese launch vehicles. To establish the model of stiffened shells that can fully take into account different forms of geometrical imperfection is an effective way to predict the buckling load of them. Moreover, it also helps the lightweight design of launch vehicles. The establishment of the geometrical imperfection database for thin-walled structures with China's independent intellectual property would help the design of the heavy-lift launch vehicles and the large aircraft in China.

The aerospace thin-walled structures carrying main load include cylindrical shells, conical shells, spherical shells and other complex curved thin-walled configurations. With the development of numerical analysis methods such as the finite element method, to establish the numerical models that fully consider all geometrical imperfections and calculate the buckling load by non-linear analysis method has become one of the ways to analyze and design these structures. For the stiffened shells, the geometrical imperfections include the deviation of the outer surface generatrix, the flatness of the end face, the radial displacement of the skin, the deviation of weld width, the deviation of weld height and the deviation of stiffener thickness. In general, a conservative knock-down factor (KDF) is used in engineering to estimate the buckling load of thin-walled structures, which limits the lightweight design and detailed design of the aerospace components. Therefore, there is an urgent need to develop a method that can establish models fully considering all geometrical imperfections and establish a geometrical imperfection database to provide guidance and specifications for the design of the heavy-lift launch vehicles and the large aircraft.

### SUMMARY OF THE INVENTION

In view of the above-described problems, the aim of the invention is to solve the problems that the existing model of the aerospace thin-walled structures cannot fully consider different types of geometrical imperfections, it is difficult to establish the detailed practical models and to collect and analyze the geometrical imperfections. In this case, this invention proposed a method for establishing the geometrical imperfection database for the aerospace thin-walled structures. The information of manufacturing features and geometrical imperfections are collected and combed by filling in the shell quality inspection card. Then the detailed numerical models that consider all geometrical imperfections can be obtained by interpolation and probability estimation methods and adjusting the node coordinates in the perfect geometrical models. It can achieve the purpose of establishing the detailed and practical models and effective combing of manufacturing features and geometrical imperfections to guide the optimization design of thin-walled structures. This method is convenient to use, can realize the feature combing of a variety of geometrical imperfections and effectively introduce these geometrical imperfections into the numerical models. Moreover, this method can establish the geometrical imperfection database for the aerospace thin-walled structures, which will provide specifications and foundation for subsequent designs of other launch vehicles and helps shorten the design cycle.

In order to achieve the above objective, there is provided a method for establishing the geometrical imperfection database for the aerospace thin-walled structure. The method comprises the following steps:

Step 1: in order to establish a geometrical imperfection database, provide a data foundation for the detailed models of the aerospace thin-walled structures carrying main load, establish a specification for the design of the aerospace thin-walled structures, a shell quality inspection card is designed and given. The shell quality inspection card is suitable and convenient to measure the geometrical imperfections for field workers. The parameters and geometrical imperfections of shells can be easily obtained by filling data of measurement points in the shell quality inspection card. Specifically:

For the stiffened cylindrical shells, the structural parameters mainly include the diameter, height, skin thickness, stiffener height, stiffener thickness, stiffener configuration and welding type; the geometrical imperfections mainly include the deviation of the outer surface generatrix, the flatness of the end face, the radial displacement of the skin, the deviation of weld width, the deviation of weld height and the deviation of stiffener thickness. The measurement methods of various geometrical imperfections are as follows. (1) the deviation of the outer surface generatrix: take some measurement lines on the outer surface of the shell at certain angles along the circle. The measurement lines should avoid longitudinal welds as much as possible, and several measurement points are equally divided along the length of the measurement line. Measure and record the radial offset value with a guiding rule, where the concave is positive and convex is negative; (2) the flatness of the end face: take some measurement points at a certain angle along the circle and measure the distance between the lower-end surface and the ground Z_{down} for these measurement points with a feeler gauge, flip the shell and measure the distance between the upper-end surface and the ground Zᵤₚ at the same position; (3) the radial displacement of the skin: judge whether there are obvious dimples on the surface of the shell by visual inspection. Then, measure and sort the dimples according to the magnitude of radial displacement of these dimples, and record the position (axial coordinate and circumferential position) and magnitude of each dimple. The concave is positive and the convex is negative; (4) the deviation of weld width and the deviation of weld height: take some measurement points along the axial or circumferential direction for each weld, measure and record the weld width and weld height of these measurement points; (5) the deviation of stiffener thickness: take some axial stiffeners at a certain angle along the circle, and take some measurement points at equal intervals along these axial stiffeners. Measure and record the stiffener thickness using the Vernier caliper and calculate its unevenness. It should be noted that these types of geometrical imperfections and measurement methods are also applicable to other thin-walled structural configurations such as conical shells, spherical shells and other complex curved thin-walled configurations.

Statistical analysis of the geometrical imperfections of a single component can be used for high-fidelity numerical analysis of the actual structure. Moreover, the accumulation of imperfection data can realize the construction of the geometrical imperfection database for the aerospace thin-walled structures, which serves the detailed analysis and design of components carrying main load and helps the lightweight of launch vehicles. The proposed shell quality inspection card template serves as a standard demonstration.

Step 2: perform characteristics combing, mathematical description and component analysis for the geometrical imperfections obtained in the first step. Specifically:

Perform the imperfection data analysis based on the shell quality inspection card using mathematical methods, such as function fitting, probability distribution and function interpolation etc. Establish appropriate mathematical models for different types of geometrical imperfection and finish the characteristics combing and mathematical description of imperfections. In specific, the function interpolation and fitting function methods are suitable for the deviation of the outer surface generatrix and the flatness of the end face. The function interpolation and function fitting methods include bilinear, nearest neighbor, cubic spline, polynomial and Fourier etc. For the radial displacement of the skin, a mathematical function of dimples can be used. For the deviation of weld width, the deviation of weld height and the deviation of stiffener thickness, the mathematical probability method can be used to describe the discrete degree of these sizes.

Furthermore, the most effective method is to use a Fourier series to fit the imperfection data for the deviation of the outer surface generatrix and the flatness of the end face. It is an efficient and accurate 3D morphology characterization method to expand the geometrical imperfections into the Fourier serious of half-wave cosine or half-wave sine in the spatial frequency domain. The general half-wave cosine double Fourier series and half-wave sine double Fourier series of cylindrical shells are expressed as follows,

$$\overline{W} ( x , y ) = {\sum }_{k = 0}^{{n}_{1}} {\sum }_{l = 0}^{{n}_{2}} cos \frac{k π x}{L} ( {A}_{kl} cos \frac{ly}{R} + {B}_{kl} sin \frac{ly}{R} ) \\ \overline{W} ( x , y ) = {\sum }_{k = 0}^{{n}_{1}} {\sum }_{l = 0}^{{n}_{2}} sin \frac{k π x}{L} ( {C}_{kl} cos \frac{ly}{R} + {D}_{kl} sin \frac{ly}{R} ) \qquad ( 3 )$$

where, W̅ is the non-dimensional out-of-plane displacement; x and y are coordinates in the circumferential and axial direction; L and R are the nominal length and radius of the cylindrical shell, respectively; Aₖₗ and Bₖₗ are the coefficients of the half-wave cosine Fourier representation describing the imperfection pattern, Cₖₗ and Dₖₗ are the coefficients of the half-wave sine Fourier representation describing the imperfection pattern; k and l are the serial number of Fourier series coefficients; n1 and n2 are the number of Fourier series coefficients. Eq. (1) can be transformed into a generalized multi-variable linear fitting problem, and coefficients can be solved by the least-squares method.

Step 3: collect and analyze the geometrical imperfection information of multiple aerospace thin-walled shells and establish the geometrical imperfection database based on the first step and second step. Specifically:

Collect the geometrical imperfection information of a group of shells based on the shell quality inspection card that is designed in the first step, and perform the characteristics combing, mathematical description and component analysis of geometrical imperfections using the method that mentioned in the second step. Then, all data are grouped, nondimensionalized and stored according to the parameters of shells and types of geometrical imperfections, and the geometrical imperfection database can be established. Based on the geometrical imperfection database, we can carry out the quality evaluation and imperfection sensitivity of the shells and develop the design specifications for different forms of thin-walled structures, which will lay a solid foundation for the design of the heavy-lift launch vehicles and large aircraft in China.

Step 4: establish the numerical finite element model that fully considers different geometrical imperfections based on the geometrical imperfection database founded in the third step. Specifically:

At first, build a perfect geometrical numerical model for a specific shell using the commercial finite element software such as the ANSYS, ABAQUS and MSC.Patran. It should be pointed out that the model is geometrically perfect and without any geometrical imperfections. Then search the shell that has similar parameters to the specific shell in the geometrical imperfection database, extract the corresponding geometrical imperfection information and reasonably shrink the mathematical description of geometrical imperfections to fit the specified shell. Finally, adjust the node coordinates and the size of welds and stiffeners of the perfect geometrical model, and the adjustment values can be obtained by the interpolation method and probability distribution function, respectively. In this case, the actual geometrical imperfections can be introduced into the finite element model and we can obtain the finite element model that fully considers different geometrical imperfections. Besides, the visualization of the geometrical imperfections can be realized by magnifying the amplitude of imperfections, which can provide a reference for designers.

Furthermore, the shell quality inspection card template suitable for the field workers and described in the first step can be used for conical shells, spherical shells and other shell configurations. The template can be used to collect and store the geometrical imperfection data and establish the geometrical imperfection database, which is crucial to establish detailed and practical numerical models and industry specifications.

Compared with existing technologies, advantages of the method according to embodiments of the invention are given below: the aim of the invention is to solve the problems that the existing model of the aerospace thin-walled structures cannot fully consider different types of geometrical imperfections generated in the manufacturing process. In order to establish the geometrical imperfection database of the aerospace thin-walled structures and build the detailed numerical model to perform the high-fidelity analysis of thin-walled structures, a shell quality inspection card that is suitable for the filed workers is designed and given. Based on the shell quality inspection card, the geometrical imperfection database can be established and a method for establishing the detailed finite element model that considers a variety of geometrical imperfection is proposed. The main geometrical imperfections generated in the manufacturing process, including the deviation of the outer surface generatrix, the flatness of the end face, the radial displacement of the skin, the deviation of weld width, the deviation of weld height and the deviation of stiffener thickness, can be collected and recorded by point-by-point measurement. Through the characteristics combing and mathematical description of these imperfection data, the geometrical imperfection database of the aerospace thin-walled structures can be established and the detailed finite element model that considers a variety of geometrical imperfections can be obtained by modifying the node coordinates of the geometrically perfect model. The geometrical imperfection database established by this invention can make full use of the actual imperfection information of test specimens, which helps to establish the numerical model that accurately reflects different geometrical imperfections and improve the authenticity and accuracy of the high-fidelity analysis. The establishment of the geometrical imperfection database of the aerospace thin-walled structures with independent intellectual property rights can effectively serve the development of the aerospace equipment in China. It helps shorten the design cycle and provide guidance and specifications for the design of the thin-walled components carrying main load.

### BRIEF DESCRIPTION OF THE DRAWINGS

FIG. 1 is an implementation flowchart of a method for establishing a geometrical imperfection database for the aerospace thin-walled structures in accordance with one exemplary embodiment of the invention;

FIG. 2 are schematic diagrams of typical geometrical imperfections in accordance with one exemplary embodiment of the invention; FIG. 2(a) is a schematic diagram of deviation of the outer surface generatrix; FIG. 2(b) is a schematic diagram of the flatness of the end face; FIG. 2(c) is a schematic diagram of deviation of the radial displacement of the skin; FIG. 2(d) is a schematic diagram of the deviation of weld width and the deviation of weld height;

FIG. 3 (a) is a schematic diagram of a characteristics combing and mathematical description for the deviation of the outer surface generatrix in accordance with one exemplary embodiment of the invention;

FIG. 3 (b) is a schematic diagram of a characteristics combing and mathematical description for the flatness of the end face in accordance with one exemplary embodiment of the invention;

FIG. 3 (c) is a schematic diagram of a characteristics combing and mathematical description for the radial displacement of the skin in accordance with one exemplary embodiment of the invention;

FIG. 3 (d) is a schematic diagram of a characteristics combing and mathematical description for the deviation of weld width and the deviation of weld height in accordance with one exemplary embodiment of the invention;

FIG. 4 is a schematic diagram of the visualization of geometrical imperfections in accordance with one exemplary embodiment of the invention.

### DETAILED DESCRIPTION OF THE EMBODIMENTS

For further illustrating the invention, experiments detailing a method for establishing the geometrical imperfection database for the aerospace thin-walled structure is described below. It should be noted that the following examples are intended to describe and not to limit the invention. Besides, it should be noted that for the convenience of description, only some parts related to the present invention are shown in the drawings instead of the entire content.

As shown in FIG. 1, a method for establishing a geometrical imperfection database for the aerospace thin-walled structures comprises the following steps:

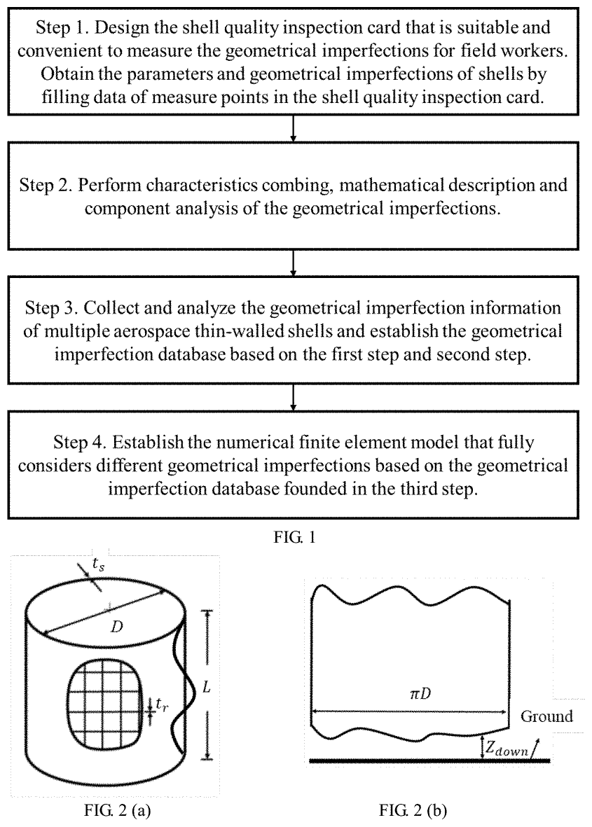

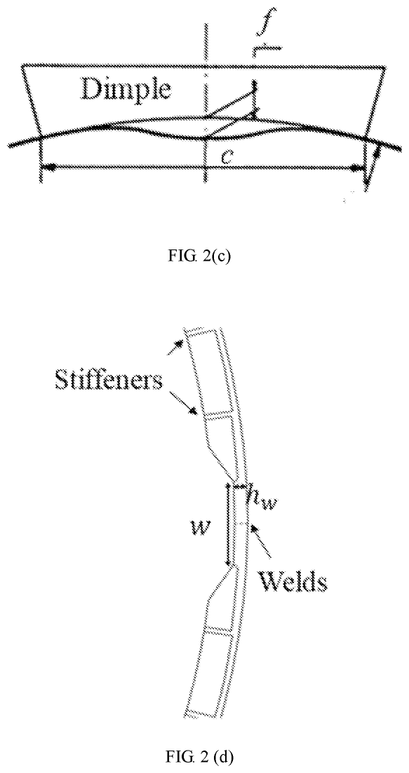

Step 1: design the shell quality inspection card that is suitable and convenient to measure the geometrical imperfections for field workers. Obtain the parameters and geometrical imperfections of shells by filling data of measurement points in the shell quality inspection card. We have collected the parameters and geometrical imperfections of 29 stiffened cylindrical shells with a diameter of about two meters by point-by-point measurement and filling the shell quality inspection card. The geometrical imperfections that are needed to measure include the deviation of the outer surface generatrix, the flatness of the end face, the radial displacement of the skin, the deviation of weld width, the deviation of weld height and the deviation of stiffener thickness. FIG. 2 is schematic diagrams of these typical geometrical imperfections. Moreover, the shell quality inspection card template used is shown in Table 1 (a) and Table 1 (b).

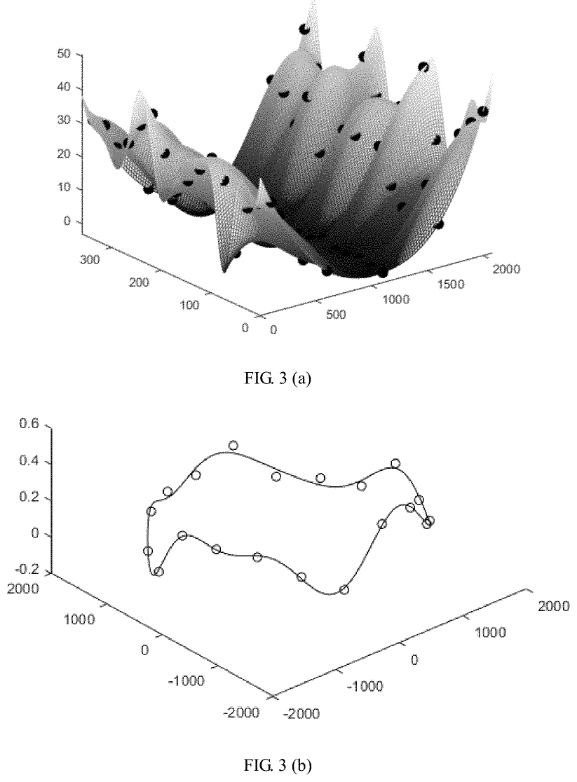

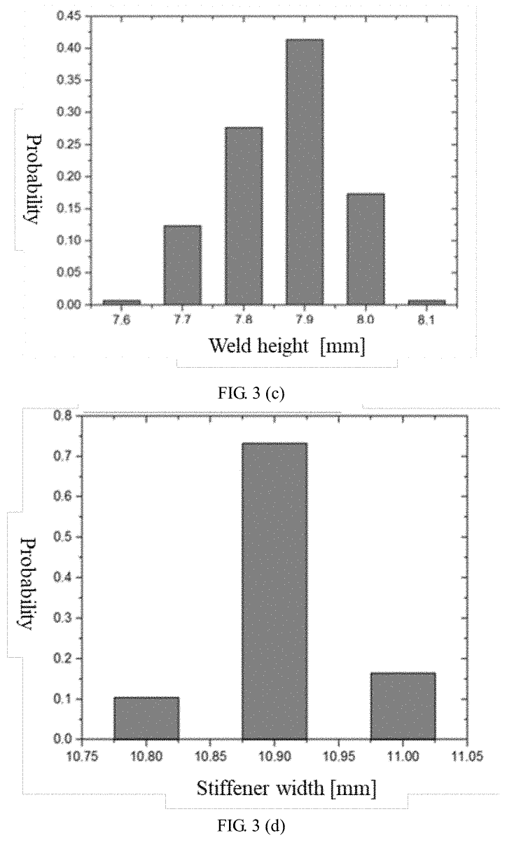

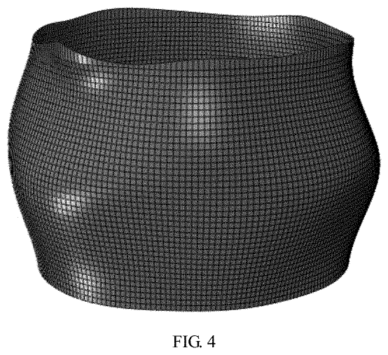

Step 2: perform characteristics combing, mathematical description and component analysis for the geometrical imperfections obtained in the first step. Establish appropriate mathematical models for different types of geometrical imperfection using function fitting, probability distribution and function interpolation methods. For the exemplary embodiment, the spline curve interpolation function method is used for the deviation of the outer surface generatrix; the flatness of the end face is fitted using the Fourier series; the mathematical probability method is used to describe the size discreteness of welds and stiffeners. The schematic diagram of a characteristics combing and mathematical description for the geometrical imperfections in accordance with one exemplary embodiment of the invention is shown in FIG. 3.

Step 3: collect and analyze the geometrical imperfection information of multiple aerospace thin-walled shells and establish the geometrical imperfection database based on the first step and second step. Collect the geometrical imperfection information of a group of shells based on the shell quality inspection card that is designed in the first step, and perform the characteristics combing, mathematical description and component analysis of geometrical imperfections using the method that mentioned in the second step. Then, all data are grouped, nondimensionalized and stored according to the parameters of shells and types of geometrical imperfections, and the geometrical imperfection database can be established.

Step 4: establish the numerical finite element model that fully considers different geometrical imperfections based on the geometrical imperfection database founded in the third step. At first, build a perfect geometrical numerical model for a specific shell using the commercial finite element software ABAQUS. It should be pointed out that the model is geometrically perfect and without any geometrical imperfections. Then search the shell that has similar parameters to the specific shell in the geometrical imperfection database, extract the corresponding geometrical imperfection information and reasonably shrink the mathematical description of geometrical imperfections to fit the specified shell. Finally, adjust the node coordinates and the size of welds and stiffeners of the perfect geometrical model, and the adjustment values can be obtained by the interpolation method and probability distribution function, respectively. In this case, the actual geometrical imperfections can be introduced into the finite element model and we can obtain the finite element model that fully considers different geometrical imperfections. In specific, for the flatness of the end face and the radial displacement of the skin, the offset value of node coordinates can be accurately calculated by the corresponding mathematical function. For the deviation of the outer surface generatrix, the spatial scatter data obtained based on the interpolation method is difficult to correspond to the nodes of model one by one. Therefore, the skin node coordinates are adjusted one by one based on the node interpolation method. Besides, the visualization of the geometrical imperfections can be realized by magnifying the amplitude of imperfections (the magnitude of geometrical imperfection is enlarged by 200 times and shown in FIG. 4), which can provide a reference for designers.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

1. A method for establishing the geometrical imperfection database for aerospace thin-walled structure, wherein, the method comprises following steps:
step 1: design a shell quality inspection card that is suitable and convenient to measure the geometrical imperfections for field workers; obtain the parameters and geometrical imperfections of shells by filling data of measurement points in the shell quality inspection card; the geometrical imperfections mainly include the deviation of the outer surface generatrix, the flatness of the end face, the radial displacement of the skin, the deviation of weld width, the deviation of weld height and the deviation of stiffener thickness;
step 2: perform characteristics combing, mathematical description and component analysis for the geometrical imperfections obtained in the first step;
perform the imperfection data analysis based on the shell quality inspection card using mathematical methods; establish appropriate mathematical models for different types of geometrical imperfection and finish the characteristics combing and mathematical description of imperfections; the function interpolation and fitting function methods are suitable for the deviation of the outer surface generatrix and the flatness of the end face; for the radial displacement of the skin, a mathematical function of dimples can be used; for the deviation of weld width, the deviation of weld height and the deviation of stiffener thickness, the mathematical probability method can be used to describe the discrete degree of these sizes;
step 3: collect and analyze the geometrical imperfection information of multiple aerospace thin-walled shells and establish the geometrical imperfection database based on the first step and second step;
collect the geometrical imperfection information of a group of shells based on the shell quality inspection card that is designed in the first step, and perform the characteristics combing, mathematical description and component analysis of geometrical imperfections using the method that in the second step; all data are grouped, nondimensionalized and stored according to the parameters of shells and types of geometrical imperfections, and the geometrical imperfection database can be established; based on the geometrical imperfection database, the quality evaluation and imperfection sensitivity of the shells can be carried out and the design specifications for different forms of thin-walled structures can be developed;
step 4: establish the numerical finite element model that fully considers different geometrical imperfections based on the geometrical imperfection database founded in the third step;
at first, build a perfect geometrical numerical model for a specific shell, the model is geometrically perfect and without any geometrical imperfections; then search the shell that has similar parameters to the specific shell in the geometrical imperfection database, extract the corresponding geometrical imperfection information and reasonably shrink the mathematical description of geometrical imperfections to fit the specified shell; finally, adjust the node coordinates and the size of welds and stiffeners of the perfect geometrical model, and the adjustment values can be obtained by the interpolation method and probability distribution function, respectively; the actual geometrical imperfections can be introduced into the finite element model and the finite element model that fully considers different geometrical imperfections can be obtained; besides, the visualization of the geometrical imperfections can be realized by magnifying the amplitude of imperfections, which can provide a reference for designers.

2. The method for establishing the geometrical imperfection database for the aerospace thin-walled structure according to claim 1, wherein, the shell quality inspection chard in the first step is suitable and convenient to measure the geometrical imperfections for field workers; these types of geometrical imperfections and measurement methods are also applicable to other thin-walled structural configurations such as conical shells, spherical shells and other complex curved thin-walled configurations; it can be used to establish the geometrical imperfection database for various structural forms, establish the detailed and practical numerical models and industry specifications.

3. The method for establishing the geometrical imperfection database for the aerospace thin-walled structure according to claim 1, wherein the measurement method for geometrical imperfections in the first step are as follows:
(1) the deviation of the outer surface generatrix: take some measurement lines on the outer surface of the shell at certain angles along the circle; the measurement lines should avoid longitudinal welds as much as possible, and several measurement points are equally divided along the length of the measurement line; measure and record the radial offset value with a guiding rule, where the concave is positive and convex is negative;
(2) the flatness of the end face: take some measurement points at a certain angle along the circle and measure the distance between the lower-end surface and the ground Z_{down} for these measurement points with a feeler gauge, flip the shell and measure the distance between the upper-end surface and the ground Zᵤₚ at the same position;
(3) the radial displacement of the skin: judge whether there are obvious dimples on the surface of the shell by visual inspection; then, measure and sort the dimples according to the magnitude of radial displacement of these dimples, and record the position and magnitude of each dimple; the concave is positive and the convex is negative;
(4) the deviation of weld width and the deviation of weld height: take some measurement points along the axial or circumferential direction for each weld, measure and record the weld width and weld height of these measurement points;
(5) the deviation of stiffener thickness: take some axial stiffeners at a certain angle along the circle, and take some measurement points at equal intervals along with these axial stiffeners; measure and record the stiffener thickness using the Vernier caliper and calculate its unevenness.

4. The method for establishing the geometrical imperfection database for the aerospace thin-walled structure according to claim 1, wherein, in the second step, for the deviation of the outer surface generatrix and the flatness of the end face, the most effective method is to use a Fourier series to fit the imperfection data, it is an efficient and accurate 3D morphology characterization method to expand the geometrical imperfections into the Fourier serious of half-wave cosine or half-wave sine in the spatial frequency domain; the general half-wave cosine double Fourier series and half-wave sine double Fourier series of cylindrical shells are expressed as follows,
$$\overline{W} ( x , y ) = {\sum }_{k = 0}^{{n}_{1}} {\sum }_{l = 0}^{{n}_{2}} cos \frac{k π x}{L} ( {A}_{kl} cos \frac{ly}{R} + {B}_{kl} sin \frac{ly}{R} ) \\ \overline{W} ( x , y ) = {\sum }_{k = 0}^{{n}_{1}} {\sum }_{l = 0}^{{n}_{2}} sin \frac{k π x}{L} ( {C}_{kl} cos \frac{ly}{R} + {D}_{kl} sin \frac{ly}{R} ) \qquad ( 1 )$$
where, W̅ is the non-dimensional out-of-plane displacement; x and y are coordinates in the circumferential and axial direction; L and R are the nominal length and radius of the cylindrical shell, respectively; Aₖₗ and Bₖₗ are the coefficients of the half-wave cosine Fourier representation describing the imperfection pattern, Cₖₗ and Dₖₗ are the coefficients of the half-wave sine Fourier representation describing the imperfection pattern; k and l are the serial number of Fourier series coefficients; n1 and n2 are the number of Fourier series coefficients; Eq. (1) can be transformed into a generalized multi-variable linear fitting problem, and coefficients can be solved by the least-squares method.

5. The method for establishing the geometrical imperfection database for the aerospace thin-walled structure according to claim 3, wherein, for the deviation of the outer surface generatrix and the flatness of the end face, the most effective method is to use a Fourier series to fit the imperfection data; it is an efficient and accurate 3D morphology characterization method to expand the geometrical imperfections into the Fourier serious of half-wave cosine or half-wave sine in the spatial frequency domain; the general half-wave cosine double Fourier series and half-wave sine double Fourier series of cylindrical shells are expressed as follows,
$$\overline{W} ( x , y ) = {\sum }_{k = 0}^{{n}_{1}} {\sum }_{l = 0}^{{n}_{2}} cos \frac{k π x}{L} ( {A}_{kl} cos \frac{ly}{R} + {B}_{kl} sin \frac{ly}{R} ) \\ \overline{W} ( x , y ) = {\sum }_{k = 0}^{{n}_{1}} {\sum }_{l = 0}^{{n}_{2}} sin \frac{k π x}{L} ( {C}_{kl} cos \frac{ly}{R} + {D}_{kl} sin \frac{ly}{R} ) \qquad ( 2 )$$
where, W̅ is the non-dimensional out-of-plane displacement; x and y are coordinates in the circumferential and axial direction; L and R are the nominal length and radius of the cylindrical shell, respectively; Aₖₗ and Bₖₗ are the coefficients of the half-wave cosine Fourier representation describing the imperfection pattern, Cₖₗ and Dₖₗ are the coefficients of the half-wave sine Fourier representation describing the imperfection pattern; k and l are the serial number of Fourier series coefficients; n1 and n2 are the number of Fourier series coefficients; Eq. (1) can be transformed into a generalized multi-variable linear fitting problem, and coefficients can be solved by the least-squares method.
